(19) United States
(12) Patent Application Publication
(10) Pub. No.: US 2026/0341199 A1
(43) Pub. Date: Oct. 29, 2026

(54) DISPLAY PIXEL DRIVEN BY PULSE WIDTH MODULATION SCHEME AND DISPLAY DEVICE INCLUDING DISPLAY PIXEL

(71) Applicant: Samsung Electronics Co., Ltd., Suwon-si (KR)

(72) Inventors: Hyun Soo Chung, Suwon-si (KR); Sunkwon Kim, Suwon-si (KR); Dongsoon Jung, Suwon-si (KR); Yongil Kwon, Suwon-si (KR); Tae-Hyeon Kwon, Suwon-si (KR); Hyunwook Lim, Suwon-si (KR)

(73) Assignee: Samsung Electronics Co., Ltd., Suwon-si (KR)

(21) Appl. No.: 19/641,274

(22) Filed: Apr. 7, 2026

(30) Foreign Application Priority Data
Apr. 24, 2025 (KR) 10-2025-0054019
Aug. 28, 2025 (KR) 10-2025-0121198

(51) Int. Cl. G09G 3/32

(52) U.S. Cl. CPC G09G 3/32; G09G 2310/0286; G09G 2310/08; G09G 2320/064; G09G 2330/021

(57) ABSTRACT

A display pixel includes a shift register including a plurality of serial bit cells, a independent bit cell, a source selection multiplexer configured to generate a pulse width modulation (PWM) signal, based on a first output signal from the shift register and a second output signal from the independent bit cell, and a light emission circuit configured to operate based on the PWM signal. During a first time period where the source selection multiplexer activates the second output signal as the PWM signal, the shift register may be configured to perform a bit rotation operation for the plurality of serial bit cells.

### CROSS-REFERENCE TO RELATED APPLICATIONS

This present application claims priority to and the benefit under 35 U.S.C. § 119(a)-(d) of Korean Patent Application No. 10-2025-0054019, filed on Apr. 24, 2025, in the Korean Intellectual Property Office, and Korean Patent Application No. 10-2025-0121198, filed on Aug. 28, 2025, in the Korean Intellectual Property Office, the entire disclosure of which are incorporated herein by reference.

### FIELD

The present disclosure relates to a display pixel and to a semiconductor display including a display pixel. More specifically, the present disclosure relates to a display pixel driven that operates based on pulse width modulation.

### BACKGROUND

A display pixel may include a light emitting diode that generates light in response to a pulse width modulation (PWM) signal. The PWM signal may determine a light emitting time length of the light emitting diode.

The logic level of the PWM signal may be determined based on a plurality of pixel drive bits corresponding to different time lengths. For example, the PWM signal may be divided into a plurality of bit emission periods, and the logic level of the PWM signal during each bit emission period may be determined based on different pixel drive bits.

An order of the plurality of bit emission periods included in the PWM signal may be same across a plurality of frames. Accordingly, depending on an arrangement of time periods of logic high (or low) in the PWM signal of previous frame and next frame, a false contour effect may occur in which display pixels seems temporarily brighter or darker compared to changes in the plurality of pixel drive bits.

### SUMMARY

A display pixel according to embodiments of present disclosure may comprise: a shift register including a plurality of serial bit cells; a independent bit cell; a source selection multiplexer configured to generate a pulse width modulation (PWM) signal, based on a first output signal from the shift register and a second output signal from the independent bit cell; and a light emission circuit configured to operate based on the PWM signal, wherein during a first time period where the source selection multiplexer activates the second output signal as the PWM signal, the shift register is configured to perform a bit rotation operation for the plurality of serial bit cells.

A display device according to embodiments of present disclosure may comprise: a column driver configured to output a plurality of bits; a display pixel configured to store the plurality of bits; and a row driver configured to: control the display pixel to perform a first light emission operation for a first subset of the plurality of bits during a first partitioned driving period; and control the display pixel to perform a second light emission operation for a second subset of the plurality of bits during a second partitioned driving period, the second partitioned driving period being included in same frame period as the first partitioned driving period, wherein the first subset and the second subset include two or more common bits.

A display pixel according to embodiments of present disclosure may comprise: a shift register configured to store a first bit and a second bit; an independent bit cell configured to store a third bit; a source selection multiplexer including a first input terminal connected to the shift register, a second input terminal connected to the independent bit cell, and an output terminal outputting a pulse width modulation (PWM) signal; and a light emission circuit configured to emit light based on the PWM signal, wherein: the source selection multiplexer is configured to determine a logic level of the PWM signal based on the first bit for a first number of times; the source selection multiplexer is configured to determine logic level of the PWM signal based on the second bit for a second number of times; and the first number is different from the second number.

### BRIEF DESCRIPTION OF THE DRAWINGS

FIG. 1 is a block diagram showing a display device according to embodiments of the present disclosure.

FIG. 2 is a block diagram showing the configuration of the display pixels of FIG. 1 in more detail.

FIG. 3 is a timing diagram showing the configuration of a PWM signal according to a comparative example.

FIG. 4 is a drawing showing a false contour effect according to the embodiments of FIG. 3.

FIG. 5 is a circuit diagram showing the configuration of a display pixel according to embodiments of the present disclosure.

FIG. 6 is a drawing showing the operation of the display pixels of FIG. 5 in more detail.

FIG. 7 is a timing diagram exemplarily showing how the row driver drives the display pixel during one light emission period according to embodiments of the present disclosure.

FIGS. 8 and 9 are timing diagrams showing the operation of the display device according to the embodiments of FIG. 7 in more detail.

FIG. 10 is a table showing the driving method described with reference to FIGS. 7 to 9 in a more concise form.

FIG. 11 is a drawing showing the size of the false contour effect according to the embodiments of FIGS. 7 to 10.

FIGS. 12 to 14 are tables showing a driving method of a display pixel according to embodiments.

FIG. 15 is a timing diagram showing one frame period implemented according to embodiments.

FIG. 16 is a block diagram showing a display system according to embodiments of the present disclosure.

FIG. 17 is a diagram exemplarily showing the configuration of the pixel driving logic table of FIG. 16 according to embodiments.

FIG. 18 is a diagram exemplarily showing the configuration of the pixel driving logic table of FIG. 16 according to embodiments.

### DETAILED DESCRIPTION

Hereinafter, embodiments of the present disclosure will be described clearly and in detail to such an extent that a person having ordinary skill in the art of the present disclosure may easily practice the present disclosure.

The components described below may be implemented as various types of software, such as firmware, applications, etc., or as various types of hardware, such as electrical circuits, electronic circuits, processors, etc. However, the scope of the present disclosure is not limited thereto, and the components described below may be implemented as a combination of software and hardware.

The present disclosure relates to a display pixel with minimized false contour effect and a display device including the same.

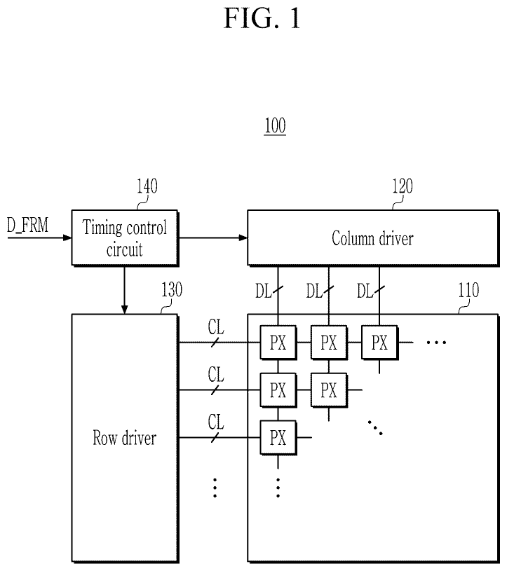

FIG. 1 is a block diagram showing a display device according to embodiments of the present disclosure. The display device 100 may include a display pixel array 110, a column driver 120, a row driver 130, and a timing control circuit 140.

The display pixel array 110 may include a plurality of display pixels PX. The plurality of display pixels PX may be arranged in a matrix form along a row direction and a column direction. However, the scope of the present disclosure is not limited thereto, and the plurality of display pixels PX may be arranged in a zigzag manner.

Each of the plurality of display pixels PX may be connected to one or more data lines DL and one or more control lines CL. For example, display pixels PX arranged in the same display pixel row may share one or more control lines CL, and display pixels PX arranged in the same display pixel column may share one or more data lines DL.

The column driver 120 may control a plurality of data lines DL. For example, the column driver 120 may provide different pixel driving data (hereinafter referred to as “PDD”) to the plurality of display pixel columns through the plurality of data lines DL.

The row driver 130 may control a plurality of control lines CL. For example, the row driver 130 may provide different pixel control signals (hereinafter referred to as “CTRL”) to the plurality of display pixel rows thorough the plurality of control lines CL.

The row driver 130 may control the plurality of display pixels PX in unit of display pixel row. For example, the row driver 130 may control the logic level of pixel control signals CTRL provided to one display pixel row, thereby controlling the operation of display pixels PX included in corresponding display pixel row. For a more detailed example, by controlling pixel control signals CTRL provided to one display pixel row, the row driver 130 may control display pixels PX included in the display pixel row to receive pixel driving data PDD from one or more data line DL, and may control display pixels PX included in the display pixel row to generate light based on the pixel driving data PDD.

The timing control circuit 140 may receive a frame data D_FRM from an external device (e.g., a CPU or GPU, etc.). The timing control circuit 140 may provide the frame data D_FRM to the column driver 120. The column driver 120 may divide the frame data D_FRM received from the timing control circuit 140 into pixel driving data PDD units, and may provide them to the display pixel array 110.

The timing control circuit 140 may control overall operations of the display device 100. For example, the timing control circuit 140 may control the operation timing of the column driver 120 and the row driver 130.

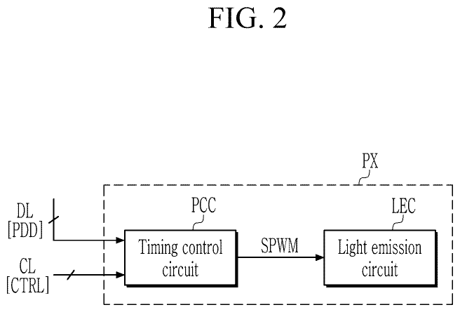

FIG. 2 is a block diagram showing the configuration of the display pixels of FIG. 1 in more detail. Referring to FIGS. 1 and 2, a display pixel PX may include a PWM control circuit PCC and a light emission circuit LEC.

The PWM control circuit PCC may receive a pixel driving data PDD through one or more data lines DL and may receive a plurality of pixel control signals CTRL through one or more control lines CL. The PWM control circuit PCC may generate a PWM signal SPWM corresponding to the pixel driving data PDD in response to the plurality of pixel control signals CTRL.

The PWM signal SPWM may include a plurality of bit emission periods (hereinafter referred to as “BEM”) having logic levels corresponding to values of the pixel driving data PDD. The PWM control circuit PCC may determine logic levels of the plurality of bit emission periods BEM based on bits included in the pixel driving data PDD.

In embodiments, each of the bits included in the pixel driving data PDD may be referred to as a ‘pixel drive bit’. However, the scope of the present disclosure is not limited to these terms.

The duty cycle (e.g., duty ratio) of the PWM signal SPWM may be determined according to the magnitude of the pixel driving data PDD. For example, the larger the magnitude of the pixel driving data PDD, the more the PWM control circuit PCC may generate the PWM signal SPWM having a great proportion of time maintained with logic high; and the smaller the magnitude of the pixel driving data PDD, the more the PWM control circuit PCC may generate the PWM signal SPWM having a small proportion of time maintained with logic high. However, the scope of the present disclosure is not limited thereto.

The light emission circuit LEC may operate in response to the PWM signal SPWM. For example, the light emission circuit LEC may include a light emitting diode configured to turned on or off based on the logic level of the PWM signal SPWM.

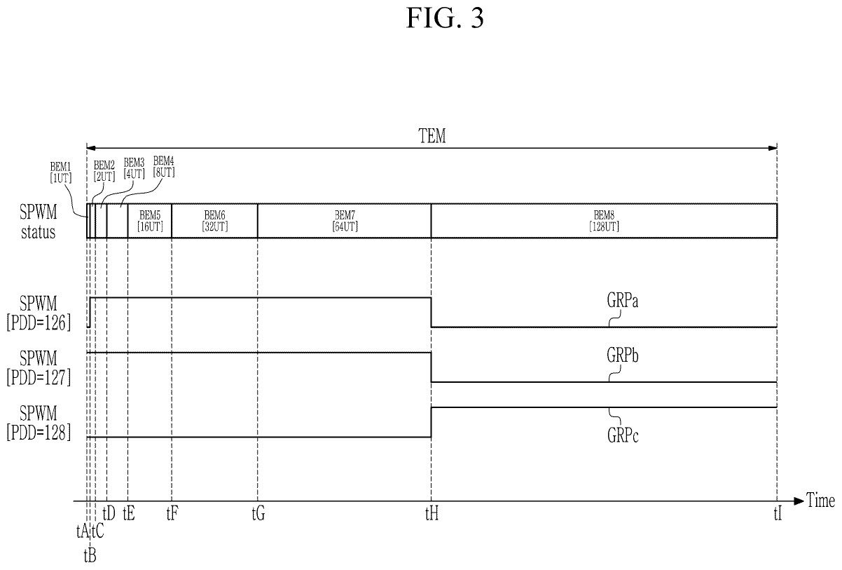

FIG. 3 is a timing diagram showing the configuration of a PWM signal according to a comparative example. Referring to FIGS. 1 to 3, whether the light emission circuit LEC emits light during a light emission period TEM may be determined based on the PWM signal SPWM. The light emission period TEM may include a plurality of bit emission periods BEM. Each of the plurality of bit emission periods BEM may correspond to a different bit included in the pixel driving data PDD and may have a different time length. For the sake of brevity, an example in which the light emission period TEM includes eight bit emission periods BEM is described below as a representative example. However, the scope of the present disclosure is not limited thereto, and the light emission period TEM may include a number of bit emission periods BEM corresponding to a code length of the pixel driving data PDD. For example, if the code length of the pixel driving data PDD is 4 bits, the light emission period TEM may include four bit emission periods BEM; if the code length of the pixel driving data PDD is 10 bits, the light emission period TEM may include ten bit emission periods BEM.

The light emission period TEM may include first to eighth bit emission periods BEM1 to BEM8. The first to eighth bit emission periods BEM1 to BEM8 may be consecutive to one another. For example, start time points of the first to eighth bit emission periods BEM1 to BEM8 may respectively correspond to time points tA to tH, and end time points of the first to eighth bit emission periods BEM1 to BEM8 may respectively correspond to the time points tB to tI, respectively. However, the scope of the present disclosure is not limited thereto. For example, an order of the first to eighth bit emission periods BEM1 to BEM8 may be determined differently (e.g., in reverse order) than that shown in FIG. 3.

The time length of each of the first to eighth bit emission periods BEM1 to BEM8 may form a geometric sequence with a common ratio of 2. For example, a time length of the first bit emission period BEM1 may be ‘1UT’, and a time length of the second bit emission period BEM2 may be ‘2UT’. In this way, a time length of the eighth bit emission period BEM8 may be ‘128UT’. The ‘1UT’ is merely a unit used to describe relative length of the plurality of bit emission periods BEMs, and the scope of the present disclosure is not limited to the specific time length of ‘1UT’.

Each of the first to eighth bit emission periods BEM1 to BEM8 may correspond to different bits included in the pixel driving data PDD. For example, the first bit emission period BEM1 may correspond to a least significant bit (LSB) of the pixel driving data PDD, and the eighth bit emission period BEM8 may correspond to a most significant bit (MSB) of the pixel driving data PDD.

The PWM control circuit PCC may determine the logic level of the PWM signal SPWM of each of the first to eighth bit emission periods BEM1 to BEM8 based on corresponding bit of pixel driving data PDD. For example, the PWM control circuit PCC may determine the logic level of the PWM signal SPWM during the first bit emission period BEM1 based on the LSB of the pixel driving data PDD, and may determine the logic level of the PWM signal SPWM during the eighth bit emission period BEM8 based on the MSB of the pixel driving data PDD.

In this way, the PWM control circuit PCC may determine the logic level of the PWM signal SPWM in units of bit emission periods BEM based on a value of the pixel driving data PDD. For example, if the value of the pixel driving data PDD is 126 (e.g., 01111110 in binary), the PWM control circuit PCC may determine the logic level of the PWM signal SPWM with logic high during the time period between the time point tB and the time point tH, as illustrated by the first graph GRPa. When the value of the pixel driving data PDD is 127 (e.g., 01111111 in binary), the PWM control circuit PCC may determine the logic level of the PWM signal SPWM to be logic high during the time period between the time point tA and the time point tH, as illustrated in the second graph GRPb. When the value of the pixel driving data PDD is 128 (e.g., 10000000 in binary), the PWM control circuit PCC may determine the logic level of the PWM signal SPWM to be logic high during the time period between the time point tH and the time point tI, as shown in the third graph GRPc.

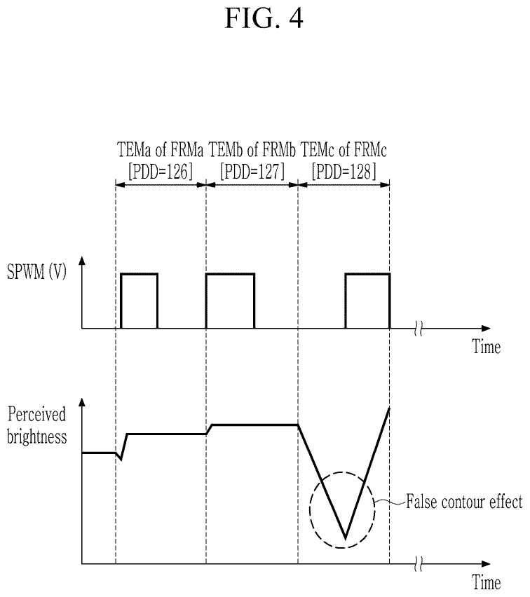

FIG. 4 is a drawing showing a false contour effect according to the embodiments of FIG. 3. Referring to FIGS. 1 to 4, the column driver 120 and the row driver 130 may drive one display pixel PX over a plurality of frame periods FRM. For example, the column driver 120 and the row driver 130 may drive one display pixel PX over the first to third frame periods FRMa to FRMc. The first to third frame periods FRMa to FRMc may be correspond to different and consecutive frames one another.

The first to third frame periods FRMa to FRMc may include first to third light emission periods TEMa to TEMc, respectively. The column driver 120 and the row driver 130 may drive the display pixels PX based on different pixel driving data PDD, during the first to third light emission periods TEMa to TEMc. For example, the column driver 120 may provide pixel driving data PDD having a value of ‘126’ to the display pixel PX in the first frame period FRMa; may provide pixel driving data PDD having a value of ‘127’ to the display pixel PX in the second frame period FRMb; and may provide pixel driving data PDD having a value of ‘128’ to the display pixel PX in the third frame period FRMc.

In response to the control of the row driver 130, the PWM control circuit PCC included in the display pixel PX may generate the PWM signal SPWM in the manner described above with reference to FIG. 3. For example, the PWM signal SPWM generated by the PWM control circuit PCC which may have a waveform similar to the first graph GRPa during the first light emission period TEMa, a waveform similar to the second graph GRPb during the second light emission period TEMb, and a waveform similar to the third graph GRPc during the third light emission period TEMc. In this case, a relative ratio of duty cycles of the PWM signal SPWM during the first to third light emission periods TEMa to TEMc may be ‘126:127:128’. Accordingly, a ratio of time lengths of the light emitting diodes included in the light emission circuit LEC are turned on during the first to third light emission periods TEMa to TEMc may also be ‘126:127:128’. In this case, the brightness of the light emission circuit LEC perceived by the human eye may also be expected to be ‘126:127:128’.

However, the brightness of the light emission circuit LEC actually perceived by the human eye may be determined as similar as a result of cumulatively considering the brightness of the light emission circuit LEC over a certain period of time. Accordingly, an error may occur in the brightness of the light emission circuit LEC perceived by the human eye when transitioning from the second frame period FRMb to the third frame period FRMc. For example, as the light emission circuit LEC emits light intensively during an earlier section of the first and second light emission periods TEMa, TEMb and emits light intensively during a later section of the third light emission period TEMc, the brightness of the light emission circuit LEC perceived by the human eye during an earlier section of the third light emission period TEMc may temporarily decrease significantly. In this case, a false contour effect may occur in which a location corresponding to the display pixel PX on the display pixel array 110 appears to be a boundary of an object, which may result in a deterioration in the quality of an image output by the display device 100. In addition, according to a similar principle, a phenomenon in which the brightness of the light emission circuit LEC perceived by the human eye temporarily increases significantly may occur depending on the values of the pixel driving data PDD corresponding to each of the first to third light emission periods TEMa to TEMc.

The difference a brightness of the light emission circuit LEC as perceived by the human eye and a intended brightness of the light emission circuit LEC may be determined by how similar the arrangements of bit emission periods BEM with logic high in the PWM signal SPWM in previous frame and next frame. For example, if logic low periods of the PWM signal SPWM are placed in the later section of the light emission period TEM as like the second frame period FRMb, and after then logic low periods of the PWM signal SPWM are concentrated in earlier section of the light emission period TEM as like the third frame period FRMc, the difference between the brightness of the light emission circuit LEC perceived by the human eye and the intended brightness of the light emission circuit LEC may be greater as the PWM signal SPWM is maintained with logic low for a long time.

That is, depending on the length and arrangement of the bit emission periods BEM, a problem may arise in which the brightness of the light emission circuit LEC is perceived by the human eye at an unintended level. In particular, such problem may be more pronounced as a time length of time period of that a logic level of the PWM signal SPWM being maintained by each bit.

According to embodiments of the present disclosure, each bit emission period BEM may be divided into two or more. In this case, a length of the time period of that a logic level of the PWM signal SPWM being maintained by each bit may be reduced. Accordingly, according to embodiments of the present disclosure, an error of the brightness of a light emission circuit LEC perceived by the human eye may be minimized.

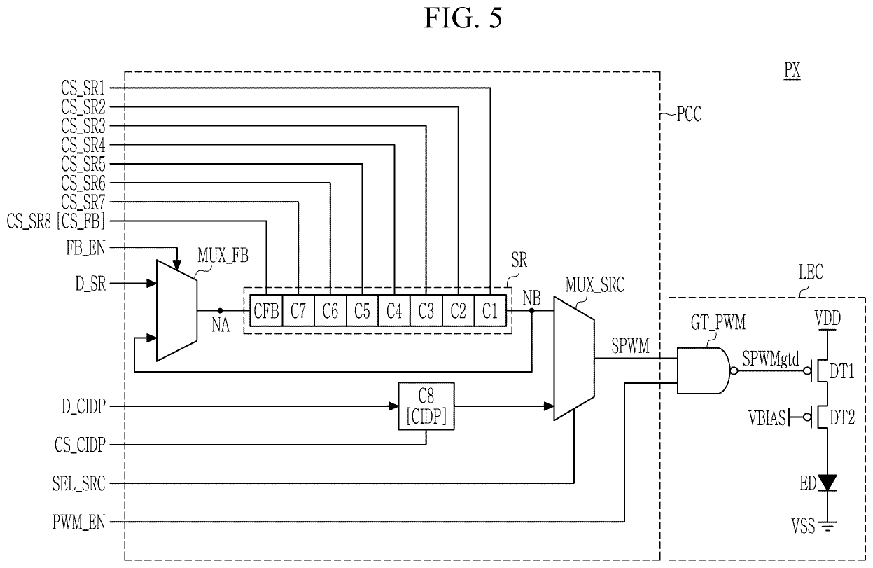

FIG. 5 is a circuit diagram showing the configuration of a display pixel according to embodiments of the present disclosure. Referring to FIGS. 1 to 5, the display pixel PX may include a PWM control circuit PCC and a light emission circuit LEC. Below, a configuration of the PWM control circuit PCC that receives 8-bit pixel driving data PDD for each frame period will be described as a representative example. However, the scope of the present disclosure is not limited thereto.

The PWM control circuit PCC may include a feedback multiplexer MUX_FB, a shift register SR, an independent bit cell CIDP, and a source selection multiplexer MUX_SRC.

The pixel driving data PDD may include a shift register data D_SR and an independent bit cell data D_CIDP. The shift register data D_SR may include LSB to secondary significant bit (e.g., the bit with the second greatest place value) of the pixel driving data PDD. The independent bit cell data D_CIDP may include the MSB of pixel driving data PDD. However, the scope of the present disclosure is not limited thereto. For example, the independent bit cell data D_CIDP may include the secondary significant bit of the pixel driving data PDD, and the shift register data D_SR may include remaining bits of the pixel driving data PDD. However, for the sake of concise explanation below, it is assumed that the independent bit cell data D_CIDP includes MSB of the pixel driving data PDD.

In embodiments, the PWM control circuit PCC may sequentially receive the shift register data D_SR one bit at a time.

In embodiments, the PWM control circuit PCC may receive the shift register data D_SR and the independent bit cell data D_CIDP through different data lines DL. For example, the PWM control circuit PCC may receive the shift register data D_SR and the independent bit cell data D_CIDP from the column driver 120 through two data lines DL. However, the scope of the present disclosure is not limited thereto. For example, the PWM control circuit PCC may time-divisionally receive the shift register data D_SR and the independent bit cell data D_CIDP from the column driver 120 through one data line DL.

The pixel control signals CTRL may include one or more shift register control signals CS_SR, a feedback enable signal FB_EN, an independent bit cell control signal CS_CIDP, a source selection signal SEL_SRC, and a PWN enable signal PWN_EN.

A first input terminal of the feedback multiplexer MUX_FB may receive the shift register data D_SR. An output terminal of the feedback multiplexer MUX_FB may be connected to a first node NA. The first node NA may be connected to the input terminal of a shift register SR. A second input terminal of the feedback multiplexer MUX_FB may be connected to a second node NB. The second node NB may be connected to an output terminal of the shift register SR.

The feedback multiplexer MUX_FB may operate in response to the feedback enable signal FB_EN. For example, the feedback multiplexer MUX_FB may determine a logic level of the first node NA to be same as a logic level of the first input terminal, while the logic level of the feedback enable signal FB_EN is logic low. The feedback multiplexer MUX_FB may determine a logic level of the first node NA to be same as a logic level of the second input terminal (or, the second node NB) while the logic level of the feedback enable signal FB_EN is logic high.

The shift register SR may be connected between the first node NA and the second node NB. The shift register SR may include a plurality of bit cells C connected in series between the first node NA and the second node NB. For example, the shift register SR may include first to seventh bit cells C1 to C7 and a feedback bit cell CFB. The feedback bit cell CFB may be connected to the first node NA, and the first bit cell C1 may be connected to the second node NB.

For a more concise explanation, embodiments in which the feedback bit cell CFB is placed between the feedback multiplexer MUX_FB and the seventh bit cell C7 is described below as a representative example. However, the scope of the present disclosure is not limited thereto. For example, the feedback bit cell CFB may be placed between the first bit cell C1 and the source selection multiplexer MUX_SRC.

The independent bit cell CIDP may include an eighth bit cell C8. That is, the independent bit cell CIDP may be implemented to store 1 bit. However, the scope of the present disclosure is not limited thereto. For example, the independent bit cell CIDP may include more than one bit cell.

Each of the first to eighth bit cells C1 to C8 and the feedback bit cell CFB may be implemented as a latch. For example, the first to seventh bit cells C1 to C7 and the feedback bit cell CFB may be implemented as latches configured to change stored data value, in response to the first to eighth shift register control signals CS_SR1 to CS_SR8, respectively. The eighth bit cell C8 may be implemented as a latch configured to change stored data value in response to the independent bit cell control signal CS_CIDP. However, the scope of the present disclosure is not limited thereto, and each of the first to eighth bit cells C1 to C8 and the feedback bit cell CFB may be implemented as any type of data storage element, such as a flip-flop. For example, if each of the first to seventh bit cells C1 to C7 and the feedback bit cell CFB is implemented as a flip-flop, each of the first to seventh bit cells C1 to C7 and the feedback bit cell CFB may be implemented to share one shift register control signal CS_SR.

In embodiments, each of the first to seventh bit cells C1 to C7 may be referred to as a serial bit cell or a serial latch. The eighth bit cell C8 may be referred to as an independent bit cell or an independent latch. However, the scope of the present disclosure is not limited to these terms.

In embodiments, the feedback bit cell CFB may operate in response to an eighth shift register control signal CS_SR8. From this perspective, the eighth shift register control signal CS_SR8 may also be referred to as a shift register feedback control signal CS_FB. However, the scope of the present disclosure is not limited to these terms.

The shift register SR may sequentially receive each bit of shift register data D_SR through the feedback multiplexer MUX_FB. For example, the shift register SR may sequentially receive the shift register data D_SR one bit at a time in response to the first to eighth shift register control signals CS_SR1 to CS_SR8, and store it in the first to seventh bit cells C1 to C7 and the feedback bit cell CFB.

The independent bit cell CIDP may directly receive independent bit cell data D_CIDP through a data line DL. For example, the eighth bit cell C8 may receive and store independent bit cell data D_CIDP in response to the independent bit cell control signal CS_CIDP.

The logic level of the output signal of the shift register SR may correspond to a bit stored in the first bit cell C1. The logic level of the output signal of the independent bit cell CIDP may correspond to a bit stored in the eighth bit cell C8.

In embodiments, the shift register SR may perform a bit rotation operation for the first to seventh bit cells C1 to C7 in response to control of the row driver 130.

For example, in response to the first to eighth shift register control signals CS_SR1 to CS_SR8, the shift register SR may move bits stored in the second to seventh bit cells C2 to C7 to the first to sixth bit cells C1 to C6 respectively, and may move bit stored in the feedback bit cell CFB to the seventh bit cell C7, and may copy bit stored in the first bit cell C1 to the feedback bit cell CFB. Accordingly, the bits stored in the first to seventh bit cells C1 to C7 may be rotated, and the feedback bit cell CFB may store the same bit as the first bit cell C1.

In embodiments, the shift register SR may perform a full rotation operation for the first to seventh bit cells C1 to C7 in response to control of the row driver 130. For example, the shift register SR may repeatedly perform the bit rotation operation as many times as a number of serial bit cells included in the shift register SR (e.g., the first to seventh bit cells C1 to C7), in response to the first to eighth shift register control signals CS_SR1 to CS_SR8. For a more detailed example, a shift register SR may perform bit rotation operations seven times. That is, the full rotation operation may refer to a bit rotation operation of as much as 7 bits.

The first input terminal of the source selection multiplexer MUX_SRC may be connected to the second node NB (e.g., the first bit cell C1). That is, the first input terminal of the source selection multiplexer MUX_SRC may receive an output signal from the shift register SR.

The second input terminal of the source selection multiplexer MUX_SRC may be connected to the eighth bit cell C8. That is, the second input terminal of the source selection multiplexer MUX_SRC may receive an output signal from an independent bit cell CIDP.

The output terminal of the source selection multiplexer MUX_SRC may output the PWM signal SPWM. The source selection multiplexer MUX_SRC may determine the logic level of the PWM signal SPWM based on the logic levels of first and second input terminals.

More specifically, the source selection multiplexer MUX_SRC may operate in response to the source selection signal SEL_SRC. For example, the source selection multiplexer MUX_SRC may determine the logic level of the PWM signal SPWM based on the bit stored in the first bit cell C1 while the logic level of the source selection signal SEL_SRC is logic low. The source selection multiplexer MUX_SRC may determine the logic level of the PWM signal SPWM based on the bit stored in the eighth bit cell C8 while the logic level of the source selection signal SEL_SRC is logic high.

In embodiments, while a full rotation operation is performed on the first to seventh bit cells C1 to C7, the bits stored in the first bit cell C1 may be sequentially changed. In this case, the bits used to determine the logic level of the PWM signal SPWM may be changed sequentially.

In this way, the row driver 130 may control the plurality of pixel control signals CTRL to cause the source selection multiplexer MUX_SRC to generate the PWM signal SPWM.

According to embodiments of the present disclosure, the independent bit cell CIDP may be physically separated from the shift register SR. In this case, the row driver 130 may freely determine the time period during which the logic level of the PWM signal SPWM is determined based on the bit stored in the independent bit cell CIDP (e.g., regardless of the order with other bit emission periods BEM). For example, the row driver 130 may divide a bit emission period BEM corresponding to a bit stored in the independent bit cell CIDP into a plurality of sub-bit emission periods (hereinafter, referred to as “SUB_BEM”). That is, the row driver 130 may divide the eighth bit emission period BEM8 into two or more sub-bit emission periods. For a more detailed example, the row driver 130 may divide the eighth bit emission period BEM8 in various ways, such as two ‘64UT’, four ‘32UT’, eight ‘16UT’, etc. Accordingly, during one light emission period TEM, a number of times the source selection multiplexer MUX_SRC determines the logic level of the PWM signal SPWM based on the bit stored in the independent bit cell CIDP may be two or more. However, the scope of the present disclosure is not limited thereto, and the row driver 130 may not divide the bit emission period BEM corresponding to the bit stored in the independent bit cell CIDP.

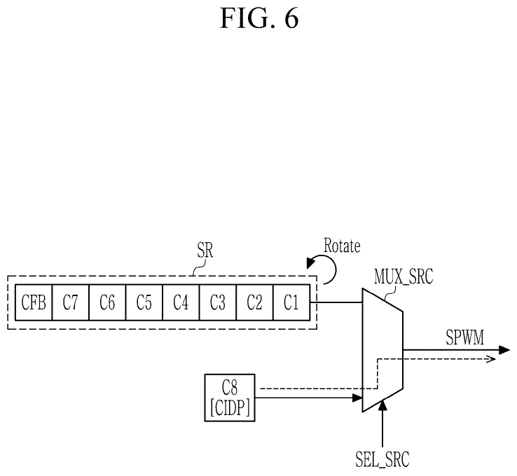

According to embodiments of the present disclosure, the row driver 130 may divide a bit emission period BEM for one or more bits stored in the shift register SR into a plurality of sub-bit emission periods SUB_BEM. For example, the row driver 130 may divide the seventh bit emission period BEM7 into two or more sub-bit emission periods SUB_BEM. More specifically, the row driver 130 may divide the seventh bit emission period BEM7 in various ways, such as two ‘32UT’, four ‘16UT’, eight ‘8UT’, etc. Accordingly, during one light emission period TEM, a number of times the source selection multiplexer MUX_SRC determines the logic level of the PWM signal SPWM based on a specific bit stored in the shift register SR may be two or more. The specific manner how the bit emission period BEM for one or more bits stored in the shift register SR is divided into the plurality of sub-bit emission periods is described in more detail with reference to FIG. 6 below.

Therefore, according to embodiments of the present disclosure, any bit emission period BEM included in one light emission period TEM may be divided into two or more sub-bit emission periods SUB_BEM. In this case, the false contour effect caused by the length of the bit emission period BEM may be minimized, and the quality of the image generated by the display device 100 may be improved.

The light emission circuit LEC may include a PWM gate GT_PWM, a first drive transistor DT1, a second drive transistor DT2, and a light emitting diode ED.

The PWM gate GT_PWM may gate the PWM signal SPWM in response to the PWM enable signal PWM_EN. For example, in response to the PWM enable signal PWM_EN, the PWM gate GT_PWM may generate a gated PWM signal SPWMgtd by gating the PWM signal SPWM.

The first drive transistor DT1 and the second drive transistor DT2 may be connected in series between a power supply voltage VDD and the light emitting diode ED. The light emitting diode ED may be connected to a ground voltage VSS. The gate terminal of the first drive transistor DT1 may receive the gated PWM signal SPWMgtd. The gate terminal of the second drive transistor DT2 may receive a bias voltage VBIAS.

The first drive transistor DT1 may provide the power supply voltage VDD to the second drive transistor DT2 during a time period where the gated PWM signal SPWMgtd is logic low. In this case, current may be supplied to the light emitting diode ED through the second drive transistor DT2, and the light emitting diode ED may be turned on (e.g., generate light).

The first drive transistor DT1 may electrically isolate the power supply voltage VDD from the second drive transistor DT2 during a time period where the gated PWM signal SPWMgtd is logic high. In this case, the second drive transistor DT2 may be turned off, so the light emitting diode ED may be turned off (e.g., not generate light).

In embodiments, the first drive transistor DT1 and the second drive transistor DT2 may be implemented as a p-type channel metal-oxide semiconductor transistor (PMOS). In this case, the PWM gate GT_PWM may perform logical NAND operations. For example, the PWM gate GT_PWM may determine the gated PWM signal SPWMgtd to be logic high while the PWM enable signal PWM_EN is logic low, and may determine the gated PWM signal SPWMgtd to habe opposite logic level of the PWM signal SPWM while the PWM enable signal PWM_EN is logic high. However, the scope of the present disclosure is not limited thereto. For example, the first drive transistor DT1 and the second drive transistor DT2 may be implemented as an n-type channel metal-oxide semiconductor transistor (NMOS). In this case, the PWM gate GT_PWM may perform a logical AND operation.

In embodiments, the light emission circuit LEC may not include the second drive transistor DT2. For example, the light emitting diode ED may be directly connected to the first drive transistor DT1. That is, the scope of the present disclosure is not limited to a specific implementation method of the light emission circuit LEC.

FIG. 6 is a drawing showing the operation of the display pixels of FIG. 5 in more detail. Referring to FIGS. 1 to 6, while the logic level of the source selection signal SEL_SRC is logic high, the source selection multiplexer MUX_SRC may determine the logic level of the PWM signal SPWM based on the bit stored in the independent bit cell CIDP.

While the logic level of the PWM signal SPWM is determined based on the bit stored in the independent bit cell CIDP, the output of the shift register SR may not affect the logic level of the PWM signal SPWM. For example, while the logic level of the PWM signal SPWM is determined based on the bit stored in the independent bit cell CIDP, even if the data output from the shift register SR changes, the logic level of the PWM signal SPWM may be determined based on the bit stored in the eighth bit cell C8 (e.g., the MSB bit of the pixel driving data PDD).

The row driver 130 may control the shift register SR to perform a bit rotation operation. For example, in response to the first to eighth shift register control signals CS_SR1 to CS_SR8, the shift register SR may shift the bits stored in the first to seventh bit cells C1 to C7. More specifically, in response to the first to eighth shift register control signals CS_SR1 to CS_SR8, the shift register SR may move bits stored in the second to seventh bit cells C2 to C7 to the first to sixth bit cells C1 to C6, move bit stored in the feedback bit cell CFB to the seventh bit cell C7, and copy bit stored in the first bit cell C1 to the feedback bit cell CFB.

In this way, while the logic level of the PWM signal SPWM is determined based on the bit stored in the independent bit cell CIDP, the row driver 130 may control the shift register SR to perform a bit rotation operation one or more times. In this case, when the logic level of the source selection signal SEL_SRC transitions to logic low after the time period where the logic level of the PWM signal SPWM is determined by the bit stored in the independent bit cell CIDP has ended, any bit stored in the shift register SR may be determined as the logic level of the PWM signal SPWM depending on a number of times the shift register SR has performed the bit rotation operation. In other words, immediately after the logic level of the source selection signal SEL_SRC transitions to logic low, any bit included in the shift register data D_SR may be used to determine the logic level of the PWM signal SPWM depending on the number of times the shift register SR performs the bit rotation operation.

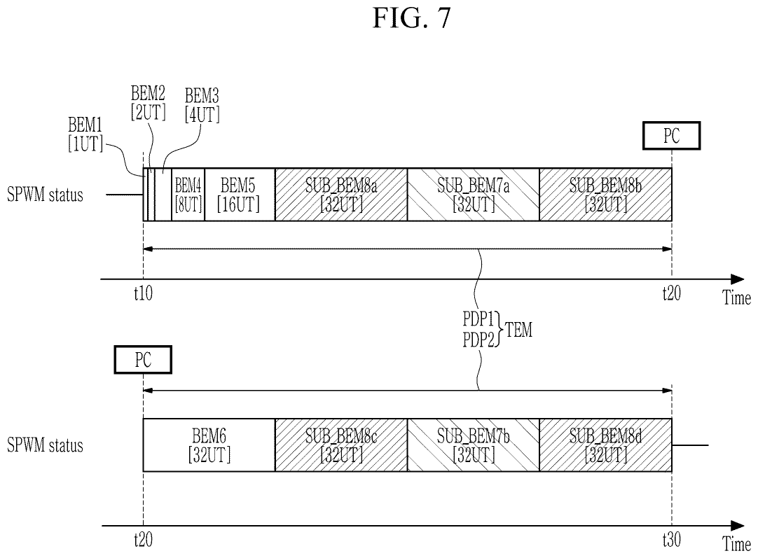

FIG. 7 is a timing diagram exemplarily showing how the row driver drives the display pixel during one light emission period according to embodiments of the present disclosure. Referring to FIGS. 1 to 7, the row driver 130 may drive one light emission period TEM by dividing it into two or more partitioned driving periods PDP. That is, one light emission period TEM may include two or more partitioned driving periods PDP.

For a more concise explanation, embodiments in which one light emission period TEM includes first and second partitioned driving periods PDP1, PDP2 is described below as a representative example. However, the scope of the present disclosure is not limited thereto, and one light emission period TEM may include any number of partitioned driving periods PDP, such as four, eight, etc.

The first partitioned driving period PDP1 may be a time period between the tenth time point t10 and the twentieth time point t20. The second partitioned driving period PDP2 may be a time period between the twentieth time point t20 and the thirtieth time point t30.

In embodiments, the length of the first partitioned driving period PDP1 and the length of the second partitioned driving period PDP2 may be different from one another.

The row driver 130 may drive the display pixel PX by dividing the bit emission period BEM corresponding to a bit stored in the independent bit cell CIDP into a plurality of sub-bit emission periods SUB_BEM. For example, the row driver 130 may drive the display pixel PX by dividing the eighth bit emission period BEM8 into the first to fourth sub-bit emission periods SUB_BEM8a to SUB_BEM8d. The first to fourth sub-bit emission periods SUB_BEM8a to SUB_BEM8d may not be sequentially consecutive to one another.

The row driver 130 may drive the display pixel PX by dividing bit emission periods BEM corresponding to one or more bits stored in the shift register SR into a plurality of sub-bit emission periods SUB_BEM. For example, the row driver 130 may drive the display pixel PX by dividing the seventh bit emission period BEM7 into the first and second sub-bit emission periods SUB_BEM7a, SUB_BEM7b. The first and second sub-bit emission periods SUB_BEM7a, SUB_BEM7b may not be sequentially consecutive to one another.

The sub-bit emission periods SUB_BEM corresponding to a bit stored in the shift register SR may be included in different partitioned driving periods PDP. For example, the first sub-bit emission period SUB_BEM7a may be included in the first partitioned driving period PDP1, and the second sub-bit emission period SUB_BEM7b may be included in the second partitioned driving period PDP2.

The sub-bit emission periods SUB_BEM corresponding to a bit stored in the independent bit cell CIDP may be arranged non-contiguously. For example, the row driver 130 may freely determine an order of the sub-bit emission periods SUB_BEM corresponding to the bits stored in the independent bit cell CIDP, as long as the sub-bit emission periods SUB_BEM are not consecutive to one another. For a more detailed example, the first partitioned driving period PDP1 may include first and second sub-bit emission periods SUB_BEM8a, SUB_BEM8b. The second partitioned driving period PDP2 may include third and fourth sub-bit emission periods SUB_BEM8c, SUB_BEM8d.

The time period where the logic level of the PWM signal SPWM is determined based on each bit stored in the shift register SR during each partitioned driving period PDP may be 1 or 0 times. For example, each of the bit emission periods BEM and sub-bit emission periods SUB_BEM included in each partitioned driving period PDP may correspond to independent bit cell data D_CIDP or may correspond to different bits included in shift register data D_SR.

The order of bit emission periods BEM for bits included in shift register data D_SR and sub-bit emission periods SUB_BEM within each partitioned driving period PDP may be determined based on the order in which each bit included in shift register data D_SR has been stored in the shift register SR.

In this way, the row driver 130 may freely determine the bits to be used for determining the logic level of the PWM signal SPWM in each partitioned driving period PDP. For example, the row driver 130 may determine the logic level of the PWM signal SPWM during the first partitioned driving period PDP1 based on a first subset of bits included in the pixel driving data PDD, and may determine the logic level of the PWM signal SPWM during the second partitioned driving period PDP2 based on a second subset of bits included in the pixel driving data PDD. For a more detailed example, the first partitioned driving period PDP1 may include the first to fifth bit emission periods BEM1 to BEM5, the first sub-bit emission period SUB_BEM8a, the first sub-bit emission period SUB_BEM7a, and the second sub-bit emission period SUB_BEM8a. The second partitioned driving period PDP2 may include a sixth bit emission period BEM6, a third sub-bit emission period SUB_BEM8c, a second sub-bit emission period SUB_BEM7b, and a fourth sub-bit emission period SUB_BEM8d.

In embodiments, the length of the first partitioned driving period PDP1 and the length of the second partitioned driving period PDP2 may be different from one another. For example, the first bit emission period BEM1 may be included in only one partitioned driving period PDP. That is, the first bit emission period BEM1 may not be divided.

In embodiments, the length of the first partitioned driving period PDP1 and the length of the second partitioned driving period PDP2 may be similar to one another. For example, the length of the first partitioned driving period PDP1 and the length of the second partitioned driving period PDP2 may differ by ‘1UT’. However, the scope of the present disclosure is not limited thereto, and the length of the first partitioned driving period PDP1 and the length of the second partitioned driving period PDP2 may differ by a significant amount of ‘1UT’ or more.

In embodiments, the boundary of the first partitioned driving period PDP1 and the second partitioned driving period PDP2 may be referred to as a partitioning criteria time point PC. For example, the twentieth time point t20 may be referred to as the partitioning criteria time point PC.

For a more concise explanation, FIG. 7 illustrates one example in which a row driver 130 arranges a plurality of bit emission periods BEM and a plurality of sub-bit emission periods SUB_BEM, but the scope of the present disclosure is not limited thereto. For example, the row driver 130 may freely determine the arrangement of the plurality of bit emission periods BEM, and may freely determine a length, a number, and an arrangement of the plurality of sub-bit emission periods SUB BEM.

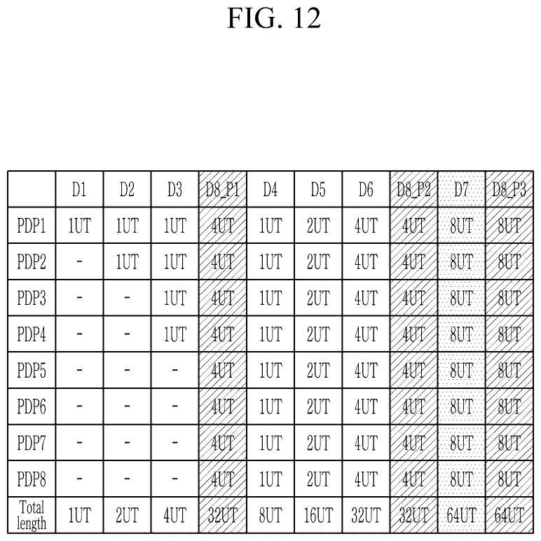

Furthermore, in FIG. 7, embodiments is representatively described in which a bit emission period BEM corresponding to only one bit (e.g., a secondary significant bit) among the plurality of bits included in shift register data D_SR has been divided into two sub-bit emission periods SUB_BEM, but the scope of the present disclosure is not limited thereto. For example, the row driver 130 may divide each of bit emission periods BEM corresponding to two or more bits included in the shift register data D_SR into two or more sub-bit emission periods SUB_BEM. Embodiments in which the row driver 130 divides each of bit emission periods BEM corresponding to two or more bits included in the shift register data D_SR into two or more sub-bit emission periods SUB_BEM is described in more detail with reference to FIGS. 12 to 14 below.

According to embodiments of the present disclosure, problems due to the length of the bit emission period BEM corresponding to a specific bit may be minimized. For example, according to embodiments of the present disclosure, not only the bit emission period BEM corresponding to the MSB of the pixel driving data PDD, but also the bit emission period corresponding to the secondary significant bit may be divided into a plurality of sub-bit emission periods SUB_BEM, so that the false contour effect may be minimized. Therefore, the display device 100 according to the embodiments of the present disclosure will be able to produce a higher quality image.

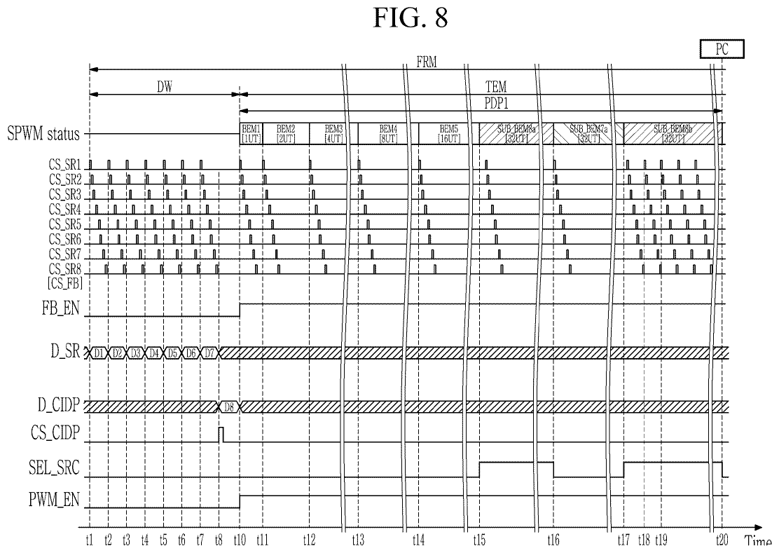

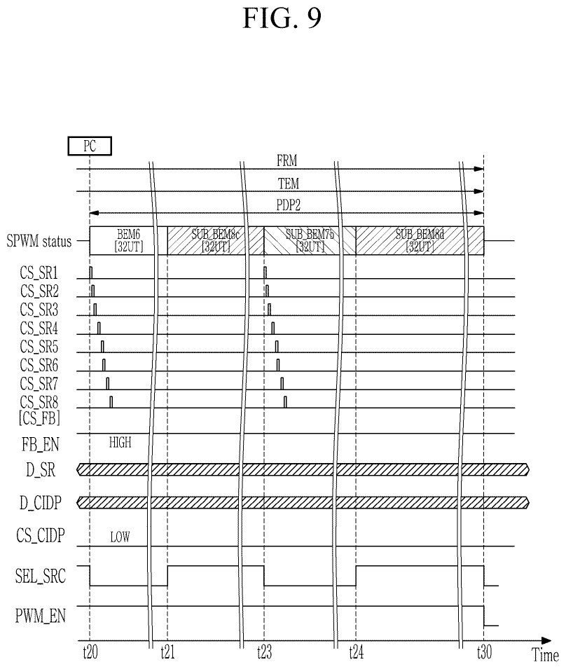

FIGS. 8 and 9 are timing diagrams showing the operation of the display device according to the embodiments of FIG. 7 in more detail. That is, below, with reference to FIGS. 1 to 9, the method how the display pixel PX of FIG. 6 is driven according to the embodiments of FIG. 7 will be described in detail.

A frame period FRM may include a data write period DW and a light emission period TEM. For the sake of brevity, embodiments in which one frame period FRM includes one light emission period TEM is described below as a representative example, but the scope of the present disclosure is not limited thereto. For example, the frame period FRM may include a plurality of sub-frames, and each of the sub-frames may include one light emission period TEM.

The data write period DW may precede the light emission period TEM. For example, the data write period DW may be a time period between a first time point t1 and a tenth time point t10.

During the data write period DW, the column driver 120 may provide bits included in pixel driving data PDD to the display pixels PX through one or more data lines DL. The display pixel PX may store pixel driving data PDD in the shift register SR and independent bit cell CIDP. For example, the shift register SR may store the shift register data D_SR, and the independent bit cell CIDP may store the independent bit cell data D_CIDP.

More specifically, the row driver 130 may set the feedback enable signal FB_EN to logic low during the data write period DW. The column driver 120 may sequentially provide the first to seventh bits D1 to D7 included in the pixel driving data PDD to the feedback multiplexer MUX_FB. In this case, the feedback multiplexer MUX_FB may sequentially provide the first to seventh bits D1 to D7 to the first node NA, and the shift register SR may sequentially store the first to seventh bits D1 to D7 in response to the control of the row driver 130.

For example, between the first time point t1 and a second time point t2, the column driver 120 may provide the first bit D1 to the feedback multiplexer MUX_FB via a data line DL. The row driver 130 may sequentially toggle (e.g., transition from logic low to logic high and then transition back to logic low). the first to eighth shift register control signals CS_SR1 to CS_SR8. In this case, the first bit D1 may be stored in the feedback bit cell CFB.

Thereafter, between the second time point t2 and the third time point t3, the column driver 120 may provide the second bit D2 to the feedback multiplexer MUX FB via the data line DL. The row driver 130 may sequentially toggle the first to eighth shift register control signals CS_SR1 to CS_SR8. In this case, the first bit D1 stored in the feedback bit cell CFB may be shifted to the seventh bit cell C7, and the second bit D2 may be newly stored in the feedback bit cell CFB.

In this way, the column driver 120 may sequentially provide the third to seventh bits D3 to D7 to the feedback multiplexer MUX_FB between the third time point t3 and the eighth time point t8. The row driver 130 may sequentially store the third to seventh bits D3 to D7 in the shift register SR by controlling the first to eighth shift register control signals CS_SR1 to CS_SR8. Accordingly, at the eighth time point t8, the first to sixth bits D1 to D6 may be stored in the second to seventh bit cells C2 to C7, respectively, and the seventh bit D7 may be stored in the feedback bit cell CFB.

For a more concise explanation, FIG. 8 is representatively described as embodiments in which the row driver 130 sequentially toggles all of the first to eighth shift register control signals CS_SR1 to CS_SR8 each time a new bit is stored in the shift register SR, but the scope of the present disclosure is not limited thereto. For example, between the first time point t1 and the second time point t2, the row driver 130 may store the first bit D1 in the feedback bit cell CFB by toggling only the eighth shift register control signal CS_SR8. Similarly, between the second time point t2 and the eighth time point t8, the row driver 130 may store the first to seventh bits D1 to D7 in the shift register SR without toggling some of the shift register control signals CS_SR. In this case, the power consumption of the row driver 130 may be minimized.

Between the eighth time point t8 and the tenth time point t10, the column driver 120 may provide the eighth bit D8 to the data line DL. The row driver 130 may toggle the independent bit cell control signal CS_CIDP. In this case, the eighth bit D8 may be stored in the eighth bit cell C8.

For a more concise explanation, FIG. 8 is representatively described as embodiments in which the eighth bit D8 is stored in the eighth bit cell C8 between the eighth time point t8 and the tenth time point t10, but the scope of the present disclosure is not limited thereto. For example, if the independent bit cell CIDP and the column driver 120 are connected via a first data line, and the feedback multiplexer MUX_FB and the column driver 120 are connected via a second data line, the eighth bit D8 may be stored in the eighth bit cell C8 earlier than the eighth time point t8. For example, the row driver 130 may toggle the independent bit cell control signal CS_CIDP at a point in time earlier than the eighth point in time t8.

In embodiments, the row driver 130 may set the PWM enable signal PWN_EN to logic low during the data write period DW. In this case, the gated PWM signal SPWMgtd may remain logic high during the data write period DW, so the light emission circuit LEC may not generate light.

At the tenth time point t10, the row driver 130 may transition the feedback enable signal FB_EN and the PWM enable signal PWM_EN to logic high. In this case, the feedback multiplexer MUX_FB may maintain the logic level of the first node NA the same as the logic level of the second node NB. That is, the feedback bit cell CFB may be connected to the first bit cell C1. The PWM gate GT_PWM may generate the gated PWM signal SPWMgtd based on the PWM signal SPWM.

At the tenth time point t10, the row driver 130 may toggle the first shift register control signal CS_SR1. In this case, the first bit D1 stored in the second bit cell C2 may be stored in the first bit cell C1, and the logic level of the second node NB may be determined based on the first bit D1. Thereafter, the row driver 130 may sequentially toggle the second to seventh shift register control signals CS_SR2 to CS_SR7 to store the second to seventh bits D2 to D7 in the second to seventh bit cells C2 to C7. Thereafter, the row driver 130 may toggle the eighth shift register control signal CS_SR8 to copy the first bit D1 stored in the first bit cell C1 to the feedback bit cell CFB. Accordingly, at the eleventh time point t11, the first to seventh bit cells C1 to C7 may store the first to seventh bits D1 to D7, respectively, and the feedback bit cell CFB may store the same bit as the first bit cell C1 (e.g., the first bit D1).

As the source selection signal SEL_SRC is logic low and the logic level of the second node NB is determined based on the first bit D1, the source selection multiplexer MUX_SRC may determine the logic level of the PWM signal SPWM to a value corresponding to the first bit D1 between the tenth time point t10 and the eleventh time point t11 (e.g., the first bit emission period BEM1).

For a more concise explanation, FIG. 8 illustrates embodiments in which the row driver 130 sequentially toggles the first to eighth shift register control signals CS_SR2 to CS_SR8 after the tenth time point t10, but the scope of the present disclosure is not limited thereto. For example, the row driver 130 may be implemented to sequentially toggle the first to eighth shift register control signals CS_SR2 to CS_SR8 between the eighth time point t8 and the tenth time point t10.

At the eleventh time point t11, the row driver 130 may control the shift register SR to perform a bit rotation operation. For example, the row driver 130 may toggle the first shift register control signal CS_SR1 at the tenth time point t10. In this case, the second bit D2 stored in the second bit cell C2 may be stored in the first bit cell C1, and the logic level of the second node NB may be determined based on the second bit D2. Thereafter, the row driver 130 may sequentially toggle the second to seventh shift register control signals CS_SR2 to CS_SR7 to sequentially move the bits stored in the third to seventh bit cells C3 to C7 to the second to sixth bit cells C2 to C6, move the first bit D1 stored in the feedback bit cell CFB to the seventh bit cell C7, and copy the bit stored in the first bit cell C1 to the feedback bit cell CFB. In this case, at the twelfth time point t12, the first to sixth bit cells C1 to C6 may store the second to seventh bits D2 to D7, respectively, the seventh bit cell C7 may store the first bit D1, and the feedback bit cell CFB may store same bit as the first bit cell C1 (e.g., the second bit D2).

As the logic level of the second node NB is determined based on the second bit D2, the source selection multiplexer MUX_SRC may determine the logic level of the PWM signal SPWM to a value corresponding to the second bit D2 between the eleventh time point t11 and the twelfth time point t12 (e.g., the second bit emission period BEM2).

The row driver 130 may control the display pixels PX in a similar manner during the third to fifth bit emission periods BEM3 to BEM5 (i.e., between the twelfth time point t12 and the fifteenth time point t15). Accordingly, at the fifteenth time point t15, the fifth to seventh bits D5 to D7 may be stored in the first to third bit cells C1 to C3, respectively, the first to fourth bits D1 to D4 may be stored in the fourth to seventh bit cells C4 to C7, respectively, and the fifth bit D5 may be stored in the feedback bit cell CFB.

The time period between the fifteenth time point t15 and the sixteenth time point t16 may correspond to the first sub-bit emission period SUB_BEM8a. The row driver 130 may maintain the source selection signal SEL_SRC at logic high between the fifteenth time point t15 and the sixteenth time point t16. In this case, the source selection multiplexer MUX_SRC may determine the logic level of the PWM signal SPWM based on a bit stored in the eighth bit cell C8.

The time period between the sixteenth time point t16 and the seventeenth time point t17 may correspond to the first sub-bit emission period SUB_BEM7a. The row driver 130 may maintain the source selection signal SEL_SRC at logic low between the sixteenth time point t16 and the seventeenth time point t17. In this case, the source selection multiplexer MUX_SRC may have to determine the logic level of the PWM signal SPWM based on the seventh bit D7 stored in the first bit cell C1.

That is, the seventh bit D7 may need to be stored in the first bit cell C1 immediately after the sixteenth time point t16. In other words, the sixth bit D6 should be stored in the first bit cell C1 immediately before the sixteenth time point t16. However, since the fifth bit D5 is stored in the first bit cell C1 immediately before the fifteenth time point t15, the shift register SR may have to perform the bit rotation operation a plurality of times (e.g., twice) immediately after the sixteenth time point t16. Accordingly, the logic level of the PWM signal SPWM may be determined based on the sixth bit D6 rather than the seventh bit D7 for a certain time length after the sixteenth point in time t16 where the bit rotation operation is performed. In this case, noise or errors may occur in the image generated by the display device 100.

According to embodiments of the present disclosure, the shift register SR may perform a bit rotation operation during the first sub-bit emission period SUB_BEM8a in response to the control of the row driver 130. For example, the row driver 130 may control the shift register SR to perform a bit rotation operation by sequentially toggling the first to eighth shift register control signals CS_SR1 to CS_SR8 during the first sub-bit emission period SUB_BEM8a. In this case, similar to what was described with reference to FIG. 6 above, the shift register SR may perform a bit rotation operation while the source selection signal SEL_SRC remains logic high, and accordingly, immediately before the sixteenth time point t16, the first bit cell C1 may be in a state where the sixth bit D6 is stored. In this case, since the value of the bit stored in the first bit cell C1 does not affect the logic level of the PWM signal SPWM while the bit rotation operation is performed, noise may not occur in the image generated by the display device 100 even if the bit rotation operation is performed.

The row driver 130 may control the display pixel PX during the first sub-bit emission period SUB_BEM7a in a similar manner as previously described with reference to the first bit emission period BEM1 and the second bit emission period BEM2.

Thereafter, during the time period between the seventeenth time point t17 and the twentieth time point t20 corresponding to the second sub-bit emission period SUB_BEM8b, the row driver 130 may maintain the source selection signal SEL_SRC at logic high. That is, the source selection multiplexer MUX_SRC may determine the logic level of the PWM signal SPWM based on the bit value stored in the eighth bit cell C8.

During the time period between the twentieth time point t20 and the twenty-first time point t21 corresponding to the sixth bit emission period BEM6, the row driver 130 may maintain the source selection signal SEL_SRC at logic low. That is, the source selection multiplexer MUX_SRC may determine the logic level of the PWM signal SPWM based on the bit value stored in the first bit cell C1.

Immediately before the seventeenth time point t17, the seventh bit D7 may be stored in the first bit cell C1. However, immediately before the twentieth time point t20, the first bit cell C1 may be in a state where the fifth bit D5 is stored (e.g., a state where the bit stored in the first bit cell C1 may be immediately changed to the sixth bit D6.

Accordingly, the shift register SR may perform a bit rotation operation (e.g., a multi-bit rotation operation) for a plurality of bits during the second sub-bit emission period SUB_BEM8b in response to the control of the row driver 130. For example, the row driver 130 may sequentially toggle the first to eighth shift register control signals CS_SR1 to CS_SR8 once between the seventeenth time point t17 and the eighteenth time point t18. In this case, the shift register SR may perform a bit rotation operation of one bit, and accordingly, the first bit D1 may be stored in the first bit cell C1. Thereafter, the row driver 130 may sequentially toggle the first to eighth shift register control signals CS_SR1 to CS_SR8 once between the eighteenth time point t18 and the nineteenth time point t19. In this case, the shift register SR may perform a bit rotation operation of one bit, thereby allowing the second bit D2 to be stored in the first bit cell C1. In this way, the row driver 130 may cause the shift register SR to repeatedly perform a bit rotation operation, thereby causing the fifth bit D5 to be stored in the first bit cell C1. In this case, immediately after the twentieth time point t20, the bit value stored in the first bit cell C1 may be immediately changed to the sixth bit D6.

In this way, the row driver 130 may control the shift register SR to perform a full rotation operation. While the shift register SR is performing the full rotation operation (e.g., between the tenth time point t10 and the seventeenth time point t17, or between the eleventh time point t11 and the eighteenth time point t18, etc.), the source selection multiplexer MUX_SRC may sequentially change the logic level of the PWM signal SPWM based on the bits included in the shift register data D_SR and the independent bit cell data D_CIDP.

That is, the row driver 130 may control the operation of the display pixels PX during the plurality of bit emission periods BEM and the plurality of sub-bit emission periods SUB_BEM by controlling the plurality of pixel control signals CTRL. The manner how the row driver 130 controls the operation of the display pixel PX during the second sub-bit emission period SUB_BEM7b and the third and fourth sub-bit emission periods SUB_BEM8c, SUB_BEM8d is similar to that described above, so a detailed description thereof is omitted.

In embodiments, the row driver 130 may determine each of the time intervals between the tenth to thirtieth time points t10 to t30 to be a predetermined length. For example, by controlling the timing of changing the logic level of the plurality of pixel control signals CTRL, the row driver 130 may set each of the time intervals among the tenth to thirtieth time points t10 to t30 with lengths of the bit emission periods BEM and sub-bit emission periods SUB_BEM described above with reference to FIG. 7.

For a more concise explanation, FIGS. 8 and 9 illustrate that the row driver 130 toggles the first shift register control signal CS_SR1 immediately after the bit emission period BEM or sub-bit emission period SUB_BEM begins, but the scope of the present disclosure is not limited thereto. For example, the row driver 130 may be implemented to toggle the first shift register control signal CS_SR1 immediately before the bit emission period BEM corresponding to each of the plurality of bits included in the shift register data D_SR or sub-bit emission period SUB_BEM starts (e.g., so that the time point when the first shift register control signal CS_SR1 transitions to logic low coincides with the time point when the bit emission period BEM or sub-bit emission period SUB_BEM starts).

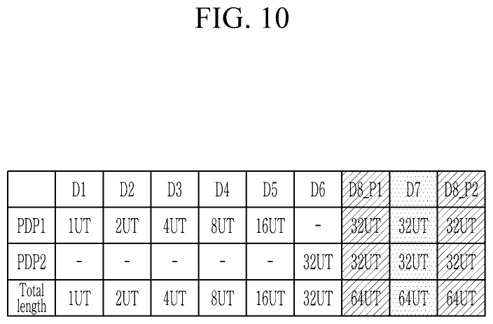

FIG. 10 is a table showing the driving method described with reference to FIGS. 7 to 9 in a more concise form. Referring to FIGS. 1 to 10, the row driver 130 may divide the light emission period TEM into a first partitioned driving period PDP1 and a second partitioned driving period PDP2.

The row driver 130 may control the logic level of the PWM signal SPWM during the first partitioned driving period PDP1 and the logic level of the PWM signal SPWM during the second partitioned driving period PDP2, based on different combinations of the plurality of bits. For example, the row driver 130 may determine the logic level of the PWM signal SPWM during the first partitioned driving period PDP1 based on the first to fifth bits D1 to D5 and the seventh to eighth bits D7 to D8, which are a first subset of bits included in the pixel driving data PDD; and may determine the logic level of the PWM signal SPWM during the second partitioned driving period PDP1 based on the sixth to eighth bits D6 to D8, which are a second subset of bits included in the pixel driving data PDD. In other words, the display pixel PX may perform a light emission operation based on the bits included in the first subset described above during the first partitioned driving period PDP1, and may perform a light emission operation based on the bits included in the second subset described above during the second partitioned driving period PDP2, in response to the control of the row driver 130.

The row driver 130 may drive the display pixels PX during the first partitioned driving period PDP1 and the second partitioned driving period PDP2 based on a predetermined order. More specifically, the row driver 130 may drive the display pixel PX to sequentially perform the light emission operation for ‘the first bit D1—the second bit D2—the third bit D3—the fourth bit D4—the fifth bit D5—the eighth bit D8_P1—the seventh bit D7—the eighth bit D8_P2’ during the first partitioned driving period PDP1, and may drive the display pixel PX to sequentially perform the light emission operation for ‘the sixth bit D6—the eighth bit D8_P1—the seventh bit D7—the eighth bit D8_P2’ during the second partitioned driving period PDP2.

In embodiments, the bits used for logic level control of the PWM signal SPWM during the first partitioned driving period PDP1 and the bits used for logic level control of the PWM signal SPWM during the second partitioned driving period PDP2 may include two or more intersections (e.g., common bits). For example, the MSB bit of the pixel driving data PDD (e.g., a bit stored in the independent bit cell CIDP) and the secondary significant bit of the pixel driving data PDD (e.g., a most significant bit among the bits stored in a shift register SR) may be used during both of the first partitioned driving period PDP1 and the second partitioned driving period PDP2. In this case, since bit emission periods BEM having a relatively long length among the bit emission periods BEM described with reference to FIG. 3 above may be divided into a plurality of sub-bit emission periods SUB_BEM, the false contour effect may be minimized. However, the scope of the present disclosure is not limited thereto. For example, one of the MSB bit and secondary significant bit of the pixel driving data PDD may not be used during one or more first partitioned driving period PDP1 and the second partitioned driving period PDP2.

In embodiments, when an independent bit cell CIDP is implemented to store the MSB of the pixel driving data PDD, because a bit emission period BEM corresponding to a bit that has the greatest influence on the false contour effect may be divided into a greater number of sub-bit emission periods SUB_BEM, the quality of the image generated by the display device 100 may be further improved. However, the scope of the present disclosure is not limited thereto.

In embodiments, each of the eighth bit D8_P1 and the eighth bit D8_P2 may be identical to the eighth bit D8. The eighth bit D8_P1 and the eighth bit D8_P2 may correspond to different time periods (e.g., phases) where the logic level of the PWM signal SPWM is determined based on the eighth bit D8 in each partitioned driving period PDP. That is, the eighth bit D8_P1 and the eighth bit D8_P2 may correspond to different sub-bit emission periods SUB_BEM for the eighth bit D8 included in each partitioned driving period PDP. For example, the eighth bit D8_P1 may correspond to the first and third sub-bit emission periods SUB_BEM8a, SUB_BEM8c, and the eighth bit D8_P2 may correspond to the second and fourth sub-bit emission periods SUB_BEM8b, SUB_BEM8d.

The sum total of the lengths of the time periods during which the first to eighth bits D1 to D8 are used to determine the logic level of the PWM signal SPWM during the light emission period TEM may be equal to the lengths of the first to eighth bit emission periods BEM1 to BEM8 described above with reference to FIG. 3. For example, the total sum of the lengths of the time periods during which the first bit D1 is used to determine the logic level of the PWM signal SPWM during the first partitioned driving period PDP1 and the second partitioned driving period PDP2 may be ‘1UT’; and the total sum of the lengths of the time periods during which the seventh bit D7 is used to determine the logic level of the PWM signal SPWM during the first partitioned driving period PDP1 and the second partitioned driving period PDP2 may be ‘64UT’; The total sum of the lengths of the time periods during which the eighth bit D8 is used to determine the logic level of the PWM signal SPWM during the first partitioned driving period PDP1 and the second partitioned driving period PDP2 may be ‘128UT’ (e.g., the sum of the total sum of the lengths of the time periods corresponding to the eighth bit D8_P1 ‘64UT’ and the total sum of the lengths of the time periods corresponding to the eighth bit D8_P2 ‘64UT’).

That is, according to embodiments of the present disclosure, the row driver 130 may divide bit emission periods BEM corresponding to one or more bits (e.g., the seventh bit D7 or more) included in the shift register data D_SR into two or more sub-bit emission periods SUB_BEM. That is, a number of times the logic level of the PWM signal SPWM is determined based on the seventh bit D7 during the light emission period TEM may be two or more. Therefore, according to embodiments of the present disclosure, the false contour effect due to the bit emission period BEM corresponding to the bit included in the shift register data D_SR may be minimized.

In embodiments, a first plurality of bits (e.g., first to fifth bits D1 to D5, seventh bit D7, and eighth bit D8) may be used to determine a logic level of a PWM signal SPWM during a first partitioned driving period PDP1; and a second plurality of bits (e.g., sixth to seventh bits D6 to D7) may be used to determine a logic level of a PWM signal SPWM during a second partitioned driving period PDP2. The arrangement order of the bit emission periods BEM and sub-bit emission periods SUB_BEM corresponding to the first plurality of bits within the first partitioned driving period PDP1, and the arrangement order of the bit emission periods BEM and sub-bit emission periods SUB_BEM corresponding to the second plurality of bits within the second partitioned driving period PDP2 may be determined based on single reference order. The reference order may be ‘first bit D1—second bit D2—third bit D3—fourth bit D4—fifth bit D5—sixth bit D6—eighth bit D8_P1—seventh bit D7—eighth bit D8_P2’. In this way, the row driver 130 may determine the order of the bit emission periods BEM and sub-bit emission periods SUB_BEM within each partitioned driving period PDP based on the predetermined reference order. In this case, the number of times a bit rotation operation is required during the light emission period TEM may be minimized. However, the scope of the present disclosure is not limited thereto, and the row driver 130 may drive the display pixels PX based on different reference order during the first partitioned driving period PDP1 and the second partitioned driving period PDP2.

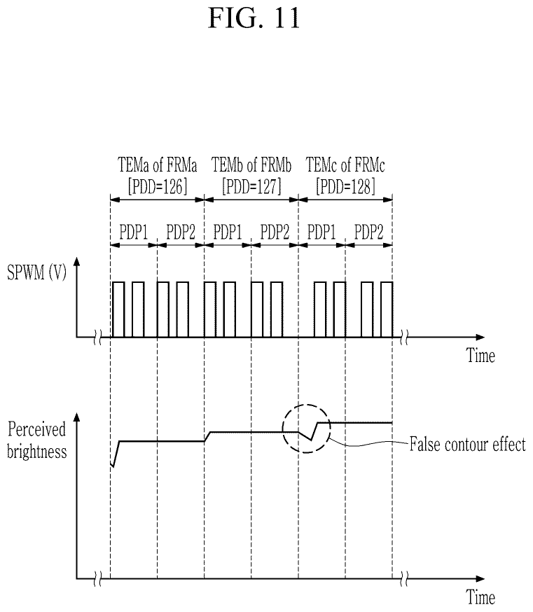

FIG. 11 is a drawing showing the size of the false contour effect according to the embodiments of FIGS. 7 to 10. Referring to FIGS. 1 to 11, the column driver 120 and the row driver 130 may drive one display pixel PX over first to third frame periods FRMa to FRMc. For example, the column driver 120 may provide pixel driving data PDD having a value of ‘126’ to the display pixel PX in the first frame period FRMa; may provide pixel driving data PDD having a value of ‘127’ to the display pixel PX in the second frame period FRMb; and may provide pixel driving data PDD having a value of ‘128’ to the display pixel PX in the third frame period FRMc.

The first to third frame periods FRMa to FRMc may include the first to third light emission periods TEMa to TEMc, respectively. Each of the first to third light emission periods TEMa to TEMc may include a first partitioned driving period PDP1 and a second partitioned driving period PDP2. That is, the row driver 130 may drive the display pixel PX in the manner described above with reference to FIGS. 7 to 10. In this case, the time period during which the display pixel PX emits light (e.g., the time period during which the PWM signal SPWM is logic high) may be distributed throughout each light emission period TEM, so the false contour effect may be minimized.

FIGS. 12 to 14 are tables showing a driving method of a display pixel according to embodiments. Referring to FIGS. 1 to 14, the row driver 130 may divide the light emission period TEM into two or more partitioned driving periods PDP. For example, the row driver 130 may divide the light emission period TEM into first to eighth partitioned driving periods PDP1 to PDP8.

In embodiments, each of the first to eighth partitioned driving periods PDP1 to PDP8 may include two or more sub-bit emission periods SUB_BEM for bit stored in independent bit cell CIDP. For example, each of the first to eighth partitioned driving periods PDP1 to PDP8 may include three sub-bit emission periods SUB_BEM for the eighth bit D8.

In embodiments, the lengths of sub-bit emission periods SUB_BEM corresponding to independent bit cell data D_CIDP included in one partitioned driving period PDP may be the same or different one another. For example, the lengths of the sub-bit emission periods SUB_BEM for the eighth bit D8 included in the first partitioned driving period PDP1 of the row driver 130 may be 4UT, 4UT, and 8UT, respectively. However, the scope of the present disclosure is not limited thereto.

In embodiments, the length and number of sub-bit emission periods SUB_BEM corresponding to independent bit cell data D_CIDP included in each partitioned driving period PDP may be the same or different one another. For example, in FIG. 12, each of the first to eighth partitioned driving periods PDP1 to PDP8 includes three sub-bit emission periods SUB_BEM corresponding to independent bit cell data D_CIDP, and the lengths of the three sub-bit emission periods SUB_BEM included in each of the first to eighth partitioned driving periods PDP1 to PDP8 are 4UT, 4UT, and 8UT, respectively, but the scope of the present disclosure is not limited thereto. For example, a particular partition driving section PDP may include sub-bit emission periods SUB_BEM corresponding to any number of independent bit cell data D_CIDP other than three; and the length of a sub-bit emission period SUB_BEM corresponding to independent bit cell data D_CIDP included in a particular partition driving section PDP may not be 4UT or 8UT.

In embodiments, each of the first to eighth partitioned driving periods PDP1 to PDP8 may include a sub-bit emission period SUB_BEM for two or more bits stored in a shift register SR. For example, each of the first to eighth partitioned driving periods PDP1 to PDP8 may include sub-bit emission periods SUB_BEM for the fourth to sixth bits D4 to D6 as well as the seventh bit D7. The first to fourth partitioned driving periods PDP1 to PDP4 may include sub-bit emission periods SUB_BEM for the third bit D3. That is, the row driver 130 may divide not only the seventh bit emission period BEM7, but also other bit emission periods BEM in a similar manner to the seventh bit emission period BEM7.

That is, according to embodiments of the present disclosure, the row driver 130 may freely determine which bit among the bits stored in the shift register SR to divide corresponding bit emission period BEM, and how many the bit emission period BEM to be divided into the sub-bit emission periods SUB_BEM to the corresponding bit into. In particular, compared to the embodiments described with reference to FIGS. 7 to 11, the embodiments illustrated in FIGS. 12 to 14 may further reduce the false contour effect, since each bit emission period BEM may be divided into sub-bit emission periods SUB_BEM having a shorter time length.

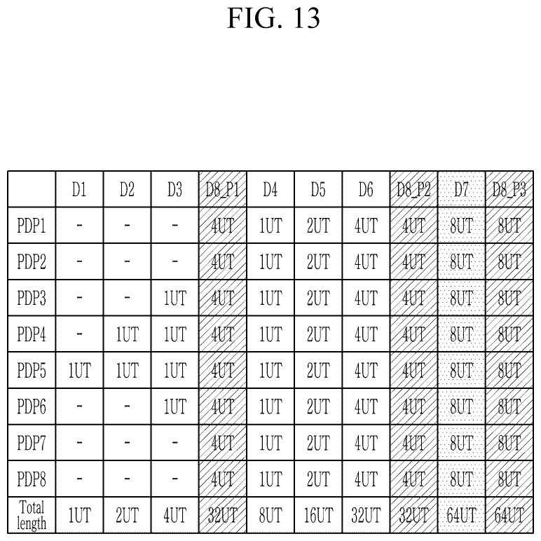

The size of the false contour effect may be different depending on the driving methods of the display pixels PX illustrated in FIGS. 12 to 14. For example, when the bit emission period BEM and sub-bit emission periods SUB_BEM for the lower bits (e.g., the first to third bits D1 to D3) of the pixel driving data PDD are concentrated in the middle of the light emission period TEM (e.g., the third to sixth partitioned driving periods PDP3 to PDP6) as illustrated in FIG. 13, the false contour effect may be reduced compared to the embodiments illustrated in FIG. 12 (e.g., in case where the bit emission period BEM and sub-bit emission periods SUB_BEM for the lower bits of the pixel driving data PDD are concentrated in the earlier section or later section of the light emission period TEM). However, the scope of the present disclosure is not limited thereto.

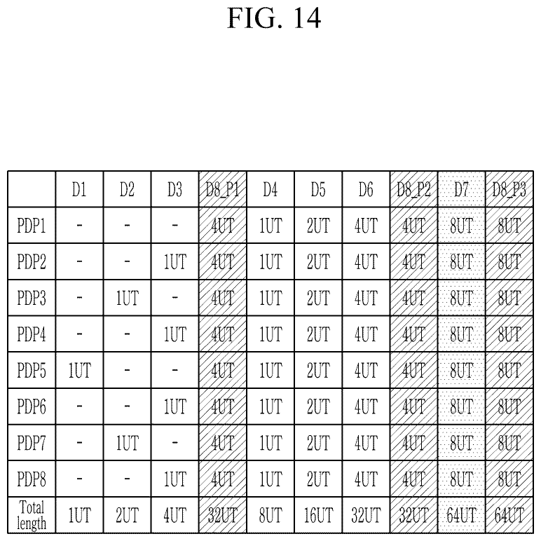

For another example, according to the embodiments illustrated in FIG. 14, the sub-bit emission periods SUB_BEM corresponding to each bit may be uniformly distributed to the first to eighth partitioned driving periods PDP1 to PDP8. For example, each of the sub-bit emission periods SUB_BEM corresponding to the third bit D3 may be included in an even-numbered partitioned driving period PDP. In this case, since the sub-bit emission periods SUB_BEM corresponding to each bit may be arranged more evenly throughout the light emission period TEM, the false contour effect may be further reduced compared to the embodiments illustrated in FIGS. 12 and 13. However, the scope of the present disclosure is not limited thereto.

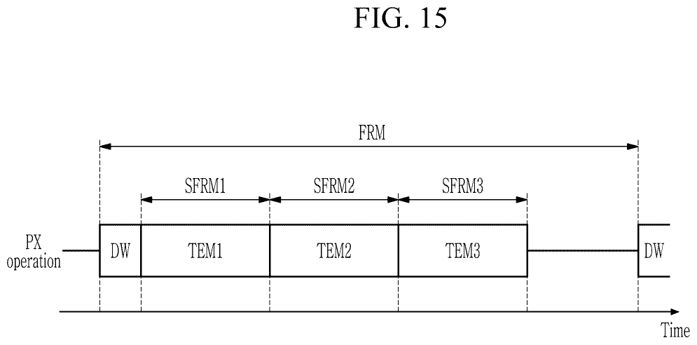

FIG. 15 is a timing diagram showing one frame period implemented according to embodiments. Referring to FIGS. 1 to 15, one frame period FRM may include a data write period DW and one or more sub-frame periods SFRM. For example, one frame period FRM may include a data write period DW and first to third sub-frame periods SFRM1 to SFRM3. However, the scope of the present disclosure is not limited thereto, and one frame period FRM may include only one sub-frame period SFRM.

In embodiments, one frame period FRM may include one data write period DW. For example, at different frame periods FRM, the display pixel PXs may receive different pixel driving data PDD. In this case, the waveforms of the PWM signals SPWM of different frame periods FRM may be different. However, the scope of the present disclosure is not limited thereto.

The first to third sub-frame periods SFRM1 to SFRM3 may share one pixel driving data PDD. For example, a display pixel PX may repeatedly use the pixel driving data PDD received in the data write period DW, in the first to third sub-frame periods SFRM1 to SFRM3. That is, the waveforms of the PWM signals SPWM of each of the first to third sub-frame periods SFRM1 to SFRM3 may be identical to one another. However, the scope of the present disclosure is not limited thereto. For example, the display pixel PX may use the plurality of bits included in pixel driving data PDD in different orders during the first to third sub-frame periods SFRM1 to SFRM3. In this case, the duty ratios (e.g., duty cycles) of the PWM signals SPWM of each of the first to third sub-frame periods SFRM1 to SFRM3 are the same, and the waveforms of the PWM signals SPWM may be different from one another.

The first to third sub-frame periods SFRM1 to SFRM3 may correspond to the first to third light emission periods TEM1 to TEM3, respectively. Each of the first to third light emission periods TEM1 to TEM3 may correspond to the light emission period TEM described above with reference to FIGS. 1 to 14. For example, the first light emission period TEM1 may include a plurality of bit emission periods BEM and a plurality of sub-bit emission periods SUB_BEM. The configuration of the second and third light emission periods TEM2, TEM3 may be the same as the configuration of the first light emission period TEM1.

That is, according to the embodiments of FIG. 15, instead of one pixel driving data PDD being used to determine logic level of the PWM signal SPWM during one long light emission period TEM, one pixel driving data PDD may be used to determine the logic level of the PWM signal SPWM during a plurality of short light emission periods TEM. In this case, the ‘1UT’ length for each light emission period TEM may be minimized, so the false contour effect may be minimized. However, the scope of the present disclosure is not limited thereto.

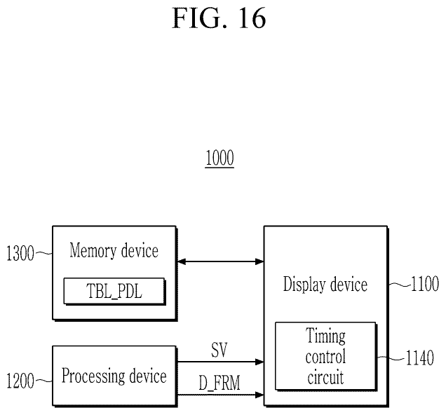

FIG. 16 is a block diagram showing a display system according to embodiments of the present disclosure. Referring to FIGS. 1 to 16, a display system 1000 may include a display device 1100, a processing device 1200, and a memory device 1300.

The display device 1100 may include a timing control circuit 1140. The display device 1100 may be implemented as the display device 100 described above with reference to FIGS. 1 to 15. In this case, the timing control circuit 1140 may correspond to the timing control circuit 140.

The processing device 1200 may provide frame data D_FRM to the display device 1100. The frame data D_FRM may include a pixel driving data PDD for each of a plurality of display pixels PX included in the display device 1100.

In embodiments, the processing device 1200 may be one of various types of computing devices, such as a central processing unit (CPU), a graphic processing unit (GPU), etc. However, the scope of the present disclosure is not limited to a specific type of processing device 1200.

The processing device 1200 may provide a setup value SV to the display device 1100. The display device 1100 may determine a specific method of driving a plurality of display pixels PX based on frame data D_FRM based on one or more setup values SV.

For a more detailed example, the timing control circuit 1140 may receive one or more setup values SV. The timing control circuit 1140 may determine pixel driving logic (hereinafter, referred to as “PDL”) corresponding to one or more setup values SV, based on accessing a pixel driving logic table TBL_PDL stored in the memory device 1300.

In embodiments, the memory device 1300 may be implemented as a non-volatile memory device such as a flash memory. However, the scope of the present disclosure is not limited thereto, and the memory device 1300 may be implemented as a volatile memory device such as a dynamic random access memory (DRAM), a static random access memory (SRAM), or the like.

The pixel driving logic PDL may represent a driving method of the display pixel PX described with reference to FIGS. 1 to 15 above. For example, the pixel driving logic PDL may indicate time points where the row driver 130 transitions the logic levels of the plurality of pixel control signals CTRL. The timing control circuit 1140 may drive display pixels PX based on the determined pixel driving logic PDL.

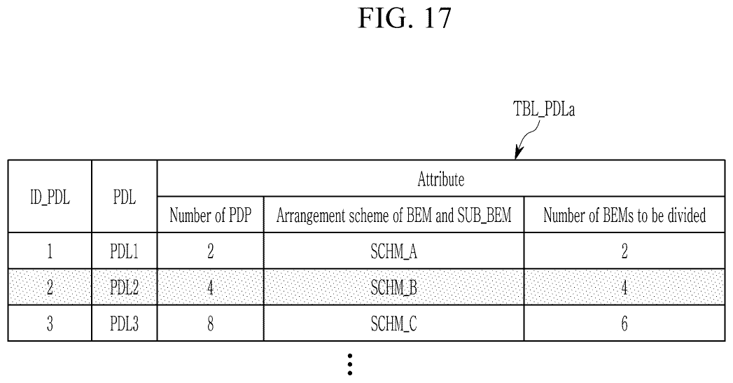

FIG. 17 is a diagram exemplarily showing the configuration of the pixel driving logic table of FIG. 16 according to embodiments. Referring to FIG. 17, the pixel driving logic table TBL_PDL of FIG. 16 may be implemented as the pixel driving logic table TBL_PDLa below.

The pixel driving logic table TBL_PDLa may include a plurality of pixel driving logics PDL. For example, the pixel driving logic table TBL_PDLa may include first to third pixel driving logics PDL1 to PDL3. Each of the first to third pixel driving logics PDL1 to PDL3 may have different properties. For example, each of the first to third pixel driving logics PDL1 to PDL3 may correspond to different combinations of i) how many partitioned driving periods PDP being partitioned from one light emission period TEM (e.g., number of PDP), ii) an arrangement scheme of bit emission periods BEM and sub-bit emission periods SUB_BEM within the light emission period TEM (e.g., arrangement scheme of BEM and SUB_BEMs, and iii) a number of bit emission periods BEM to be divided (e.g., number of BEM to be divided).

For a more detailed example, the first pixel driving logic PDL1 may be an operation algorithm for dividing one light emission period TEM into two partitioned driving periods PDP; arranging bit emission periods BEM and sub-bit emission periods SUB_BEM within the light emission period TEM in a first scheme SCHM_A (e.g., a scheme described above with reference to FIG. 12); and dividing one bit emission period BEM (e.g., a bit emission period BEM corresponding to MSB) into a plurality of sub-bit emission periods SUB_BEM. The second pixel driving logic PDL2 may be an operation algorithm for dividing one light emission period TEM into four partitioned driving periods PDP; arranging bit emission periods BEM and sub-bit emission periods SUB_BEM within the light emission period TEM in a second scheme SCHM_B (e.g., the scheme described above with reference to FIG. 13); and dividing four bit emission periods BEM (e.g., bit emission periods BEM corresponding to the four bits upper of the pixel driving data PDD) into a plurality of sub-bit emission periods SUB_BEM. The third pixel driving logic PDL3 may be an operation algorithm for dividing one light emission period TEM into eight partitioned driving periods PDP; arranging bit emission periods BEM and sub-bit emission periods SUB_BEM within the light emission period TEM in a third scheme SCHM_C (e.g., the scheme described above with reference to FIG. 14); and dividing six bit emission periods BEM (e.g., bit emission periods BEM corresponding to the six upper bits of the pixel driving data PDD) into a plurality of sub-bit emission periods SUB_BEM. However, the scope of the present disclosure is not limited to the number of pixel driving logics PDL included in the pixel driving logic table TBL_PDLa and the specific properties of each pixel driving logic PDL.

Each of the plurality of pixel driving logics PDL included in the pixel driving logic table TBL_PDLa may correspond to a different pixel driving logic identifier ID_PDL. For example, the first to third pixel driving logics PDL1 to PDL3 may correspond to pixel driving logic identifiers ID_PDL ‘1’ to ‘3’, respectively.

The timing control circuit 1140 may receive one setup value SV from the processing device 1200. The timing control circuit 1140 may read out the pixel driving logic PDL corresponding to a pixel driving logic identifier ID_PDL indicated by a setup value SV received from the memory device 1300. For example, if the received setup value SV includes the pixel driving logic identifier ID_PDL ‘2’, the timing control circuit 1140 may read the second pixel driving logic PDL2 from the memory device 1300. The timing control circuit 1140 may drive a plurality of display pixels PX by controlling the row driver 130 and the column driver 120 based on the second pixel driving logic PDL2.

That is, according to the embodiments of FIG. 17, the processing device 1200 may change the pixel driving logic PDL used to drive the display pixels PX of the display device 1100 based on the setup value SV. In this way, the processing device 1200 may change the pixel driving logic PDL used to drive the display pixels PX of the display device 1100 depending on the illumination of the environment to which the display system 1000 is exposed, the request of the user of the display system 1000, etc.

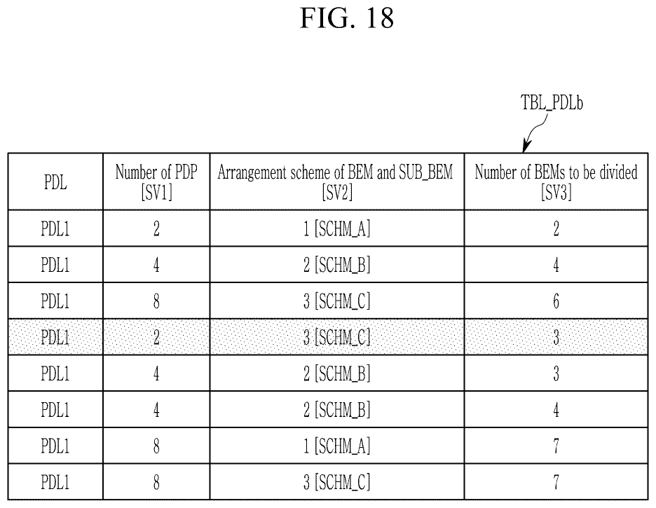

FIG. 18 is a diagram exemplarily showing the configuration of the pixel driving logic table of FIG. 16 according to embodiments. Referring to FIG. 18, the pixel driving logic table TBL_PDL of FIG. 16 may be implemented as the pixel driving logic table TBL_PDLb below.

The pixel driving logic table TBL_PDLa may include a plurality of pixel driving logics PDL. For example, the pixel driving logic table TBL_PDLa may include first to eighth pixel driving logics PDL1 to PDL8. Similar to what was previously described with reference to FIG. 17, each of the first to eighth pixel driving logics PDL1 to PDL8 may have different properties.

The timing control circuit 1140 may receive a plurality of setup values SV from the processing device 1200. For example, the timing control circuit 1140 may receive first to third setup values SV1 to SV3 from the processing device 1200. The timing control circuit 1140 may read pixel driving logic PDL corresponding to the first to third setup values SV1 to SV3 from the memory device 1300. For a more detailed example, when the first to third setup values SV1 to SV3 are ‘2’, ‘3’, and ‘3’, respectively, the timing control circuit 1140 may read the fourth pixel driving logic PDL4 from the memory device 1300. In this case, the timing control circuit 1140 may control the row driver 130 and the column driver 120 based on the fourth pixel driving logic PDL4 to drive a plurality of display pixels PX.

That is, according to the embodiments of FIG. 18, the processing device 1200 may change the pixel driving logic PDL used to drive the display pixels PX of the display device 1100 based on a plurality of setup values SV. In this way, the processing device 1200 may change the pixel driving logic PDL used to drive the display pixels PX of the display device 1100 depending on the illumination of the environment to which the display system 1000 is exposed, the request of the user of the display system 1000, etc.

For a more concise explanation, FIGS. 16 to 18 illustrate embodiments in which a display device 1100 selects one of a plurality of pixel driving logics PDLs stored in a memory device 1300 in response to a request from a processing device 1200, but the scope of the present disclosure is not limited thereto. For example, the display device 1100 may be implemented to directly generate pixel driving logic PDL based on a plurality of setup values SV provided from the processing device 1200. That is, the scope of the present disclosure is not limited to the specific manner in which pixel driving logic PDL is changed.

The above-described contents are specific embodiments for carrying out the present disclosure. However, the scope of the present disclosure is not limited thereto and should be determined based on the claims set forth below and their equivalents.

What is claimed is:

1. A display pixel, comprising:
a shift register including a plurality of serial bit cells;
an independent bit cell;
a source selection multiplexer configured to generate a pulse width modulation (PWM) signal, based on a first output signal from the shift register and a second output signal from the independent bit cell; and
a light emission circuit configured to operate based on the PWM signal,
wherein during a first time period where the source selection multiplexer activates the second output signal as the PWM signal, the shift register is configured to perform a bit rotation operation for the plurality of serial bit cells.

2. The display pixel of claim 1, wherein the shift register is configured to:
perform a first full rotation operation for the plurality of serial bit cells between a first time point and a second time point included in one frame period,
perform a second full rotation operation for the plurality of serial bit cells between the second time point and a third time point included in the frame period.

3. The display pixel of claim 2, wherein the shift register is configured to:
repeat the bit rotation operation a first number of times corresponding to a second number of the plurality of serial bit cells, between the first and second time points.

4. The display pixel of claim 2, wherein:
a waveform of the PWM signal between the first and second time points is different from a waveform of the PWM signal between the second and third time points.

5. The display pixel of claim 4, wherein:
a combination of bits used to determine logic level of the PWM signal between the first and second time points is different from a combination of bits used to determine logic level of the PWM signal between the second and third time points.

6. The display pixel of claim 2, wherein:
the shift register is configured to output a first bit as the first output signal during a second time period included between the first and second time points,
the shift register is configured to output the first bit as the first output signal during a third time period included between the second and third time points,
the source selection multiplexer is configured to determine a logic level of the PWM signal during the second time period and the third time period based on the first bit.

7. The display pixel of claim 6, wherein:
the first time interval is included between the first and second time points,
the source selection multiplexer is configured to activate the second output signal as the PWM signal during a fourth time period included between the second and third time points.

8. The display pixel of claim 6, wherein:
a total time length where the source selection multiplexer activates the second output signal as the PWM signal during the frame period is approximately twice a total time length where the source selection multiplexer determines logic level of the PWM signal based on the first bit during the frame period.

9. The display pixel of claim 1, wherein:
the plurality of serial bit cells include first to n-th serial bit cells,
the shift register further includes a feedback bit cell storing same bit as the first serial bit cell,
during the first time period, the shift register is configured to respectively move bits stored in the second to n-th serial bit cells to the first to (n−1)-th serial bit cells, move a bit stored in the feedback bit cell to the n-th serial bit cell, and copy a bit stored in the first serial bit cell to the feedback bit cell.

10. The display pixel of claim 1, wherein:
the plurality of serial bit cells are implemented as a plurality of serial latches connected in series with one another, and
the independent bit cell is implemented as an independent latch.

11. The display pixel of claim 1, wherein the light emission circuit comprises:
a light emitting diode; and
a drive transistor configured to operate based on the PWM signal, the drive transistor being connected between a power supply voltage and the light emitting diode.

12. A display device, comprising:
a column driver configured to output a plurality of bits;
a display pixel configured to store the plurality of bits; and
a row driver configured to:
control the display pixel to perform a first light emission operation for a first subset of the plurality of bits during a first partitioned driving period; and
control the display pixel to perform a second light emission operation for a second subset of the plurality of bits during a second partitioned driving period, the second partitioned driving period being included in same frame period as the first partitioned driving period,
wherein the first subset and the second subset include two or more common bits.

13. The display device of claim 12, wherein:
the first partitioned driving period and the second partitioned driving period are included in one sub-frame period.

14. The display device of claim 12, wherein:
a length of the first partitioned driving period and a length of the second partitioned driving period are different from one another.

15. The display device of claim 12, wherein:
the plurality of bits include first to n-th bits,
the display pixel comprises:
a shift register configured to store the first to (n−1)-th bits;
an independent bit cell configured to store the n-th bit; and
a source selection multiplexer including a first input terminal connected to the shift register, a second input terminal connected to the independent bit cell, and an output terminal outputting a pulse width modulation (PWM) signal.

16. The display device of claim 15, wherein the two or more common bits includes:
the n-th bit and one of the first to (n−1)-th bits.

17. The display device of claim 12, further comprising a timing control circuit, wherein the timing control circuit is configured to:
receive a setup value from a first external device;
receive a pixel driving logic corresponding to the setup value from a second external device; and
determine the first subset and the second subset based on the pixel driving logic.

18. A display pixel, comprising:
a shift register configured to store a first bit and a second bit;
an independent bit cell configured to store a third bit;
a source selection multiplexer including a first input terminal connected to the shift register, a second input terminal connected to the independent bit cell, and an output terminal outputting a pulse width modulation (PWM) signal; and
a light emission circuit configured to emit light based on the PWM signal,
wherein:
the source selection multiplexer is configured to determine logic level of the PWM signal based on the first bit for a first number of times;
the source selection multiplexer is configured to determine logic level of the PWM signal based on the second bit for a second number of times; and
the first number is different from the second number.

19. The display pixel of claim 18, wherein the shift register is configured to perform a bit rotation operation during a first time period where logic level of the PWM signal is determined based on the third bit.

20. The display pixel of claim 18, wherein:
a total time length where the source selection multiplexer determines logic level of the PWM signal based on logic level of the first input terminal during the first frame period is shorter than a total time length during where the source selection multiplexer determines logic level of the PWM signal based the logic level of the second input terminal during the frame period.
